(19) United States
(12) Patent Application Publication
(10) Pub. No.: US 2023/0136555 A1
(43) Pub. Date: May 4, 2023

(54) POLYURETHANE DISPERSIONS

(71) Applicant: Covestro Deutschland AG, Leverkusen (DE)

(72) Inventors: Joerg Buechner, Bergisch Gladbach (DE); Rainer Trinks, Dormagen (DE); Thomas Fait, Troisdorf (DE); Oliver Kirstein, Wuppertal (DE)

(21) Appl. No.: 17/908,324

(22) PCT Filed: Mar. 15, 2021
(86) PCT No.: PCT/EP2021/056445

§ 371 Date: Aug. 31, 2022

(30) Foreign Application Priority Data
Mar. 17, 2020 (EP) 20163701.4

(51) Int. Cl. C09D 175/06; C08K 5/14; C08K 5/1535

(52) U.S. Cl. CPC C09D 175/06; C08K 5/14; C08K 5/1535

(57) ABSTRACT

The present invention relates to aqueous dispersions containing at least one polyurethane and at least one compound with a biocidal action, the at least one compound with a biocidal action containing at least one peroxide group and being present in a quantity of between 0.01 and 1,000 mmol/kg, in relation to the total aqueous dispersion, and relates to a process for preparing a biocide-free aqueous polyurethane dispersion, said process comprising at least the steps: (A) preparing an aqueous solution containing at least one polyurethane and at least one compound with a biocidal action, the at least one compound with a biocidal action containing at least one peroxide group and being present in a quantity of between 0.01 and 1,000 mmol/kg, in relation to the total aqueous dispersion; and (B) treating the aqueous dispersion from step (A) with at least one compound with an anti-oxidative action, in order to obtain the biocide-free aqueous polyurethane dispersion, and in addition relates to the use of at least one compound with an anti-oxidative action for treating an aqueous dispersion containing at least one polyurethane and at least one compound with a biocidal action, the at least one compound with a biocidal action containing at least one peroxide group and being present in a quantity of between 0.01 and 1,000 mmol/kg, in relation to the total aqueous dispersion.

The present invention relates to an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion, to a process for preparing a biocide-free aqueous polyurethane dispersion, comprising at least the steps (A) providing an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion, and (B) treating the aqueous dispersion from step (A) with at least one compound having an antioxidant effect, in order to obtain the biocide-free aqueous polyurethane dispersion, and also to the use of at least one compound having an antioxidant effect for treating an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

Aqueous polyurethane dispersions, the addition of reagents having biocidal effects to preserve the dispersions, and the use of corresponding dispersions are already known to those skilled in the art.

DE 19810819 discloses a process for treating liquid coating materials which comprise an in-can preservative. For this purpose, a reagent is added to the coating material immediately before use thereof, which decomposes the in-can preservative. Isothiazolinones are disclosed as suitable in-can preservatives; examples of suitable in-can preservatives are chloromethylisothiazolinone, methylisothiazolinone, benzisothiazolinone, octylisothiazolinone or methyltrimethyleneisothiazolinone. Sodium thiosulfate, sodium bisulfite, sodium metabisulfite or sodium sulfite are mentioned in particular as reagents which can decompose these preservatives.

WO 2002/007698 discloses cosmetically or dermatologically active preparations comprising an antioxidant which can convert peroxides or hydroperoxides to the corresponding alcohols.

US 2018/258300 discloses a printer ink composition comprising synthetic resin particles, for example polyurethane particles, pigments, glycol ethers and water. This composition may comprise additives, for example preservatives. Furthermore, the water with which the composition is produced may be treated in advance with hydrogen peroxide to remove microbes.

US 2017/156340 discloses antimicrobial coatings for implants, medical instruments, devices or hospital equipment. For this purpose, a polymer provided with a metal derivative is attached to the surface, which develops a biocidal effect in the presence of hydrogen peroxide.

JP 2018 053 170 discloses a printer ink comprising a dispersion of crosslinkable, urethane-based resin. The printer ink may also comprise preservatives. Furthermore, the water used to produce the printer ink may be treated with hydrogen peroxide beforehand to make it sterile.

The object of the present invention is to provide an aqueous polyurethane dispersion which, on the one hand, exhibits consistently high quality and consistently good performance properties up to the time of its processing, in particular for customers, and, on the other hand, during its processing, is largely free from biocidal compounds which may interfere with processing, in particular for the production of articles, cosmetics, coatings, adhesives or adhesive layers. Accordingly, the intention is that it will be possible in particular to remove the biocidal compounds present without great complexity and cost such that the polyurethane dispersion is largely residue-free prior to use thereof.

These objects are achieved by the aqueous dispersion according to the invention comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

Furthermore, these objects are achieved by the process according to the invention for preparing a biocide-free aqueous polyurethane dispersion, comprising at least the steps of
(A) providing an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion, and
(B) treating the aqueous dispersion from step (A) with at least one compound having an antioxidant effect in order to obtain the largely biocide-free aqueous polyurethane dispersion.

These objects are also achieved by the use according to the invention of at least one compound having an antioxidant effect for treating an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

The present invention is described in detail below.

The aqueous dispersion according to the invention comprises at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

In accordance with the invention, any polyurethane known to those skilled in the art can generally be used in an aqueous dispersion.

According to the invention, aqueous dispersions comprising at least one polyurethane are understood to mean an aqueous dispersion comprising polyurethane polymers and/or polyurethane-polyurea polymers.

Polyurethanes preferred according to the invention comprise as structural components:
(a) at least one diol and/or polyol component,
(b) at least one di- and/or polyisocyanate component,
(c) at least one component having at least one hydrophilizing group,
(d) optionally mono-, di- and/or triamino-functional and/or hydroxyamino-functional compounds and
(e) optionally other isocyanate-reactive compounds.

Suitable diol and/or polyol components (a) are compounds having at least two isocyanate-reactive hydrogen atoms and an average molecular weight of preferably 62 to 18 000 g/mol, particularly preferably 62 to 4000 g/mol.

Examples of suitable structural components (a) are polyether polyols, polyester polyols, polycarbonate polyols, polylactones and polyamides. Preferred polyols (a) preferably have 2 to 4, particularly preferably 2 to 3 hydroxyl groups, especially preferably 2 hydroxyl groups. Mixtures of various such compounds are also possible.

While the teaching of the present invention can in principle be realized with any dispersed polyurethane or polyurethane-urea polymer, the at least one polyurethane present in the aqueous dispersion according to the invention preferably comprises as component (a) one or more polyester polyols and/or one or more polyether polyols and/or one or more polycarbonate polyols. The aqueous dispersion as claimed in claim 1, characterized in that the at least one polyurethane is based on polyether polyols and/or polyester polyols and/or polycarbonate polyols.

The present invention therefore preferably relates to the aqueous dispersion according to the invention, the at least one polyurethane being based on at least one polyester polyol, preferably polyester diol, and/or at least one polyether polyol, preferably polyether diol, and/or at least one polycarbonate polyol, preferably polycarbonate diol.

Suitable polyester polyols are in particular linear polyester diols or also sparsely branched polyester polyols, as can be produced in a known manner from aliphatic, cycloaliphatic or aromatic di- or polycarboxylic acids such as succinic acid, methylsuccinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid, cyclohexanedicarboxylic acid, maleic acid, fumaric acid, malonic acid or trimellitic acid, and acid anhydrides such as o-phthalic, trimellitic or succinic anhydride or mixtures thereof with polyhydric alcohols, such as ethanediol, di-, tri-, tetraethylene glycol, propane-1,2-diol, di-, tri-, tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol or mixtures thereof, optionally with the additional use of higher-functional polyols such as trimethylolpropane, glycerol or pentaerythritol. Cycloaliphatic and/or aromatic di- and polyhydroxyl compounds are of course also suitable as polyhydric alcohols for producing the polyester polyols. In place of the free polycarboxylic acid, it is also possible to use for the production of the polyesters the corresponding polycarboxylic anhydrides or corresponding polycarboxylic esters of lower alcohols or mixtures thereof.

The polyester polyols may also be homopolymers or copolymers of lactones, which are obtained preferably through the addition of lactones or lactone mixtures, such as butyrolactone, ε-caprolactone, and/or methyl-ε-caprolactone, onto suitable difunctional and/or higher-functional starter molecules, such as the low-molecular-weight, polyhydric alcohols mentioned above as structural components for polyester polyols. Preference is given to the corresponding polymers of ε-caprolactone.

Polycarbonates having hydroxyl groups are also suitable as polyhydroxyl components (a), for example those that can be produced by reacting diols such as butane-1,4-diol and/or hexane-1,6-diol with diaryl carbonates, for example diphenyl carbonate, dialkyl carbonates, for example dimethyl carbonate, or phosgene. The at least partial use of polycarbonates having hydroxyl groups can improve the resistance to hydrolysis of the polyurethane or polyurethane-urea dispersion adhesives, if the dispersions according to the invention are used for producing adhesives.

Examples of suitable polyether polyols are the polyaddition products of styrene oxides, of ethylene oxide, propylene oxide, tetrahydrofuran, butylene oxide, epichlorohydrin, and mixed addition and grafting products thereof, and also the polyether polyols obtained by condensation of polyhydric alcohols or mixtures of the same and obtained by alkoxylation of polyhydric alcohols, amines, and amino alcohols. Polyether polyols particularly suitable as structural components (a) are homopolymers, copolymers, and graft polymers of propylene oxide, of ethylene oxide and of tetrahydrofuran, which are accessible by addition of the epoxides mentioned or of tetrahydrofuran onto low-molecular-weight diols or triols, such as those mentioned above as structural components for polyester polyols, or onto higher-functional low-molecular-weight polyols such as pentaerythritol or sugar, or onto water.

Suitable components (a) are also low-molecular-weight diols, triols, and/or tetraols such as ethanediol, di-, tri-, tetraethylene glycol, propane-1,2-diol, di-, tri-, tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol, neopentyl glycol, cyclohexane-1,4-diol, cyclohexane-1,4-dimethanol, 1,4-, 1,3-, 1,2-dihydroxybenzene or 2,2-bis(4-hydroxyphenyl)propane (bisphenol A), TCD diol, trimethylolpropane, glycerol, pentaerythritol, dipentaerythritol or mixtures thereof, optionally with the additional use of other diols or triols not mentioned.

Polyols used may also be reaction products of the recited polyols, in particular of low-molecular-weight polyols, with ethylene oxide and/or propylene oxide.

The low-molecular-weight components (a) preferably have a molecular weight of 62 to 400 g/mol and are further preferably used in combination with the polyester polyols, polylactones, polyether polyols and/or polycarbonate polyols described above.

The polyol component (a) is preferably present in the polyurethane according to the invention to an extent of 20 to 95% by weight, particularly preferably to an extent of 30 to 90% by weight, and especially preferably to an extent of 65 to 90% by weight, in which the sum of components (a), (b), (c), optionally (d) and optionally (e) present is 100% by weight in each case.

Suitable as components (b) are any organic compounds having at least two free isocyanate groups per molecule. Preference is given to using diisocyanates of general formula Y(NCO)₂, wherein Y is a divalent aliphatic hydrocarbon radical having 4 to 12 carbon atoms, a divalent cycloaliphatic hydrocarbon radical having 6 to 15 carbon atoms, a divalent aromatic hydrocarbon radical having 6 to 15 carbon atoms or a divalent araliphatic hydrocarbon radical having 7 to 15 carbon atoms. Examples of such diisocyanates to be used with preference are tetramethylene diisocyanate, methylpentamethylene diisocyanate, pentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane (isophorone diisocyanate; IPDI), 4,4′-diisocyanatodicyclohexylmethane, 4,4′-diisocyanato-2,2-dicyclohexylpropane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures consisting of these compounds.

In addition to these simple diisocyanates, polyisocyanates containing heteroatoms in the radical linking the isocyanate groups and/or having a functionality of more than 2 isocyanate groups per molecule are also suitable. The former are polyisocyanates having a uretdione, isocyanurate, urethane, allophanate, biuret, carbodiimide, iminooxadiazinedione, and/or oxadiazinetrione structure that are prepared for example by modification of simple aliphatic, cycloaliphatic, araliphatic and/or aromatic diisocyanates and composed of at least two diisocyanates. An example of an unmodified polyisocyanate having more than 2 isocyanate groups per molecule is, for example, 4-isocyanatomethyloctane 1,8-diisocyanate (nonane triisocyanate).

Preferred diisocyanates (b) are pentamethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 1,3- and 1,4-bis(isocyanatomethyl)benzene, 1,3- and 1,4-bis(1-isocyanato-1-methylethyl)benzene, bis(4-(1-isocyanato-1-methylethyl)phenyl) carbonate, 4,4′-diisocyanato-2,2-dicyclohexylpropane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures consisting of these compounds.

Particularly preferred components (b) are 2,4-diisocyanatotoluene, 2,6-diisocyanatotoluene, hexamethylene diisocyanate, 4,4′-diisocyanatodicyclohexylmethane, 1-isocyanato-3,3,5-trimethyl-5-isocyanatomethylcyclohexane, and also mixtures consisting of these compounds.

Component (b) is present in the polyurethane used according to the invention in an amount of generally 5 to 60% by weight, preferably 6 to 45% by weight, and particularly preferably 7 to 25% by weight, in which the sum of components (a), (b), (c), optionally (d) and optionally (e) present is 100% by weight in each case.

Suitable components (c) are, for example, components comprising sulfonate or carboxylate groups, for example diamino compounds and dihydroxy compounds additionally bearing sulfonate and/or carboxylate groups, for example the sodium, lithium, potassium, tert-amine salts of N-(2-aminoethyl)-2-aminoethanesulfonic acid, N-(3-aminopropyl)-2-aminoethanesulfonic acid, N-(3-aminopropyl)-3-aminopropanesulfonic acid, N-(2-aminoethyl)-3-aminopropanesulfonic acid, the analogous carboxylic acids, dimethylolpropionic acid, dimethylolbutyric acid, the reaction products in the sense of a Michael addition of 1 mol of diamine, for example ethane-1,2-diamine or isophoronediamine, with 2 mol of acrylic acid or maleic acid.

The acids are preferably used directly in the form of their sulfonate or carboxylate salts. However, it is also possible to add some or all of the neutralizing agents necessary for salt formation only during or after production of the polyurethanes.

For the salt formation, particularly suitable and preferred tert. amines are, for example, triethylamine, dimethylcyclohexylamine and/or ethyldiisopropylamine. Other amines may also be used for salt formation, for example ammonia, diethanolamine, triethanolamine, dimethylethanolamine, methyldiethanolamine, aminomethylpropanol and also mixtures of the amines cited and also other amines. It is advisable not to add these amines until after the prepolymer has formed.

It is also possible to use for neutralization purposes other neutralizing agents, for example sodium, potassium, lithium and calcium hydroxides.

Further suitable components (c) are non-ionically hydrophilizing, mono- or difunctional polyethers based on ethylene oxide polymers or ethylene oxide/propylene oxide copolymers started on alcohols or amines, for example polyether LB 25 (Covestro Deutschland AG, Leverkusen, Germany) or MPEG 750, i.e. methoxypolyethylene glycol having a molecular weight of 750 g/mol, obtainable for example under the trade name Pluriol® 750 from BASF SE, Germany).

Preferred components (c) are N-(2-aminoethyl)-2-aminoethanesulfonate, N-(2-aminoethyl)-2-aminoethanecarboxylate, and the salts of dimethylolpropionic acid and dimethylolbutyric acid.

Component (c) is present in the polyurethane according to the invention preferably in an amount of 0.1 to 15% by weight, particularly preferably 0.5 to 10% by weight, especially preferably 0.8 to 5% by weight, and even more preferably 0.9 to 3.0% by weight, the sum of the components (a), (b), (c), optionally (d) and optionally (e) present being 100% by weight in each case.

Suitable components (d) according to the invention are mono-, di-, trifunctional amines and/or mono-, di-, trifunctional hydroxyamines, for example aliphatic and/or alicyclic primary and/or secondary monoamines, for example ethylamine, diethylamine, the isomeric propyl- and butylamines, higher linear aliphatic monoamines and cycloaliphatic monoamines, for example cyclohexylamine. Further examples are amino alcohols, i.e. compounds comprising amino and hydroxyl groups in the same molecule, for example ethanolamine, N-methylethanolamine, diethanolamine, diisopropanolamine, 1,3-diamino-2-propanol, N-(2-hydroxyethyl)ethylenediamine, N,N-bis(2-hydroxyethyl)ethylenediamine and 2-propanolamine.

Further examples are diamines and triamines, for example ethane-1,2-diamine, hexamethylene-1,6-diamine, 1-amino-3,3,5-trimethyl-5-aminomethylcyclohexane (isophoronediamine), piperazine, 1,4-diaminocyclohexane, bis(4-aminocyclohexyl)methane, and diethylenetriamine. Adipic dihydrazide, hydrazine, and hydrazine hydrate are additionally suitable. It is of course also possible to use mixtures of a plurality of the compounds (d) mentioned, optionally also together with compounds (d) that are not mentioned.

Preferred components (d) are ethane-1,2-diamine, 1-amino-3,3,5-trimethyl-5-aminomethylcyclohexane, diethylenetriamine, diethanolamine, ethanolamine, N-(2-hydroxyethyl)ethylenediamine, and N,N-bis(2-hydroxyethyl)ethylenediamine.

Components (d) serve as di- or trifunctional chain extenders, preferably in order to build up higher molecular weights, or in the form of monofunctional compounds to limit molecular weights, and/or optionally as a means of incorporating additional reactive groups such as free hydroxyl groups. If (poly)amines (D) are not used, the polymers formed are pure polyurethanes which further preferably do not comprise any urea groups.

Component (d) is present in the polyurethane according to the invention preferably in an amount of 0 to 10% by weight, particularly preferably 0 to 5% by weight, and especially preferably 0.2 to 3% by weight, in which the sum of components (a), (b), (c), optionally (d) and optionally (e) present is 100% by weight in each case.

The components (e) to be optionally used according to the invention may be for example aliphatic, cycloaliphatic or aromatic monoalcohols having 2 to 22 carbon atoms, for example ethanol, butanol, hexanol, cyclohexanol, isobutanol, benzyl alcohol, stearyl alcohol, 2-ethylethanol, and common blocking agents for isocyanate groups that can be cleaved off again at elevated temperatures, for example butanone oxime, dimethylpyrazole, caprolactam, malonic ester, triazole, dimethyltriazole, tert-butylbenzylamine, cyclopentanone carboxyethyl ester.

Components (e) may be present in the polyurethane according to the invention, preferably in an amount of 0 to 20% by weight, particularly preferably 0 to 10% by weight, in which the sum of components (a), (b), (c), optionally (d) and optionally (e) present is 100% by weight in each case.

The additional use of component (e) can result for example in polyurethane dispersions according to the invention comprising other reactive groups in addition to the reactive carboxyl groups, which enables for example the use of different crosslinking mechanisms, for example dual cure, to achieve specific properties, for example a two-step curing process, optionally with a time interval between the steps, or a particularly high crosslinking density.

The lateral and/or terminal carboxyl groups can in principle be incorporated into the polymer skeleton via any of the structural components (a) to (e). They are preferably incorporated via components (c), (d) and/or (e).

Incorporation via component (c) can be accomplished for example by using dimethylolpropionic acid or dimethylolbutyric acid in the absence of neutralizing agent or with neutralizing agent added in a substoichiometric amount.

Compounds suitable for the incorporation of carboxyl groups as components (d) are, for example, those comprising only one isocyanate-reactive amino group and thus in the production of the polyurethanes according to the invention resulting in terminal carboxyl groups by reaction with the isocyanate component. Linear aliphatic, branched aliphatic, aliphatic-aromatic, and aromatic aminocarboxylic acids are suitable. Examples include aminocarboxylic acids having a primary or secondary amino group, such as alanine, 6-aminohexanoic acid, aminoundecanoic acid, 8-aminooctanoic acid, 5-aminopentanoic acid, 4-aminobutyric acid, aminobenzoic acid, 4-aminomethylcyclohexanecarboxylic acid, 2-aminohexanoic acid, 4-aminocyclohexanecarboxylic acid, 12-aminododecanoic acid and/or 9-aminononacarboxylic acid.

Further compounds suitable for the incorporation of carboxyl groups as components (d) are, for example, diaminocarboxylic acids having 2 isocyanate-reactive amino groups and thus in the production of the polyurethanes according to the invention giving rise to lateral carboxyl groups by reaction with the isocyanate components. Examples of these are lysine, arginine and/or histidine.

Compounds suitable for the incorporation of carboxyl groups as components (e) are, for example, hydroxycarboxylic acids each comprising only one hydroxyl group, for example hydroxypivalic acid, hydroxyacetic acid and/or 2-hydroxypropanoic acid.

For production of the aqueous dispersions according to the invention, it is possible to use all methods known from the prior art, such as emulsifier-shear force, acetone, prepolymer mixing, melt emulsification, ketimine and solid-state spontaneous dispersion methods or derivatives thereof. A summary of these methods can be found in Methoden der organischen Chemie [Methods of Organic Chemistry] (Houben-Weyl, Erweiterungs- und Folgebände zur 4. Auflage [Expansion and Supplementary Volumes for the 4th Edition], volume E20, H. Bartl and J. Falbe, Stuttgart, New York, Thieme 1987, pages 1671 to 1682). In accordance with the invention, preference is given to the melt emulsification, prepolymer mixing, and the acetone method. Particular preference is given to the acetone method. The use and implementation of the acetone method is prior art and is known to the person skilled in the art, from EP-A 0 232 778 for example.

The at least one polyurethane can generally be present in the aqueous dispersion according to the invention at any concentration deemed suitable to a person skilled in the art. The at least one polyurethane is preferably present in the aqueous dispersion according to the invention in an amount of 5 to 64% by weight, particularly preferably 30 to 60% by weight, especially preferably 40 to 50% by weight, based in each case on the total aqueous dispersion.

The aqueous dispersion according to the invention comprises at least one compound having a biocidal effect. In the context of the present invention, “having a biocidal effect” means that the corresponding compound can control microorganisms, in particular bacteria and/or fungi, and prevent them from multiplying or kill them.

The at least one compound having a biocidal effect present in the aqueous dispersion used in accordance with the invention comprises at least one, preferably one, peroxide group. The peroxide group is known per se to a person skilled in the art and corresponds to the formula —O—O—.

In general, all biocidal compounds known to the person skilled in the art having at least one peroxide group, preferably inorganic compounds having at least one peroxide group, may be used according to the invention. According to the invention, at least one biocidal compound having at least one peroxide group is preferably selected from the group consisting of hydrogen peroxide, alkali metal and alkaline earth metal peroxides, in particular sodium hyperoxide, peroxomonosulfuric acid, peroxodisulfuric acid, peracetic acid, sodium percarbonate and mixtures thereof. Hydrogen peroxide, in particular an aqueous solution of hydrogen peroxide, is especially preferably used according to the invention.

The at least one compound having a biocidal effect comprising at least one compound bearing a peroxide group is present in the aqueous dispersion according to the invention in an amount of 0.01 to 1000 mmol/kg, preferably 0.01 to 500 mmol/kg, particularly preferably 0.1 to 100 mmol/kg, especially preferably 1 to 50 mmol/kg, based in each case based on the total aqueous dispersion.

In addition to the at least one polyurethane and the at least one biocidal compound, any component which appears suitable to the person skilled in the art may be present in the aqueous dispersion according to the invention. Examples of components additionally present are binders known in coating and adhesives technology, assistants and additives, in particular emulsifiers and light stabilizers, particularly UV absorbers, also fillers and auxiliaries, in particular anti-settling agents, defoaming and/or wetting agents, leveling agents, reactive diluents, plasticizers, neutralizing agents, catalysts, auxiliary solvents, thickeners, additives, in particular pigments, dyes or matting agents, tackifiers, or mixtures thereof.

The present invention therefore preferably relates to the aqueous dispersion according to the invention, in which additional components are present selected from binders, assistants and additives, fillers, auxiliaries, leveling agents, reactive diluents, plasticizers, neutralizing agents, catalysts, auxiliary solvents, thickeners, additives, tackifiers and mixtures thereof.

The advantage of the aqueous dispersion according to the invention, inter alia, is that it remains microbe-free over a period of at least 6 months due to the presence of the at least one biocidal compound, provided that it is in an originally sealed container. Furthermore, the aqueous dispersion according to the invention can be freed from the at least one biocidal compound in a simple and efficient manner before further processing, so that this does not interfere with the further processing.

The present invention therefore also relates to the process for producing a biocide-free aqueous polyurethane dispersion, comprising at least the steps of
(A) providing an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion, and
(B) treating the aqueous dispersion from step (A) with at least one compound having an antioxidant effect in order to obtain the biocide-free aqueous polyurethane dispersion.

The individual steps of the process of the invention are described in detail hereinbelow.

Step (A) of the process according to the invention comprises the provision of an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

Details and preferred embodiments of the aqueous dispersion provided in step (A) of the process according to the invention have already been described above and apply accordingly to the process according to the invention.

“Provide” in the context of the present invention means that the aqueous dispersion may be present in any form that appears suitable to the person skilled in the art in which it is possible to be treated according to step (B) of the process according to the invention. The aqueous dispersion is preferably provided in a container or reactor, for example a stirred reactor. The at least one compound having an antioxidant effect may also be added after decanting the aqueous dispersion into a mixing container, in particular equipped with a stirrer or circulating pump. The at least one compound having an antioxidant effect may also be added directly to the supply container.

In accordance with the invention, the aqueous dispersion has the concentrations of ingredients described above. According to the invention, however, it is also possible for the aqueous dispersion to be diluted or concentrated before step (A). Suitable concentrations of the at least one polyurethane present are 10 to 64% by weight, preferably 30 to 60% by weight, especially preferably 40 to 50% by weight, based in each case on the total aqueous dispersion.

According to the invention, before step (B) of the process according to the invention, the aqueous dispersion may be mixed with at least one further aqueous polymer dispersion, for example with an aqueous dispersion of at least one polyolefin or at least one polyacrylate.

Step (B) of the process according to the invention comprises treating the aqueous dispersion from step (A) with at least one compound having an antioxidant effect in order to obtain the biocide-free aqueous polyurethane dispersion.

In principle, in step (B) of the process according to the invention, it is possible to use any compound or mixture thereof having an antioxidant effect known to the person skilled in the art, and which has a sufficiently high redox potential, to reduce the peroxide group present. According to the invention, the at least one compound having an antioxidant effect is preferably selected from the group of naturally occurring antioxidant compounds, particularly preferably selected from the group consisting of ascorbic acid, salts of ascorbic acid, cysteine, acetylcysteine, L-glutathione, methionine and mixtures thereof. According to the invention, alkali metal salts of ascorbic acid, preferably sodium ascorbate, are especially preferably used as the compounds having an antioxidant effect.

According to the invention, the at least one compound having an antioxidant effect may be used in any amount suitable for the person skilled in the art. The at least one compound having an antioxidant effect is preferably added in a molar ratio of peroxide (—O—O—) to antioxidant of 0.1 to 10, particularly preferably 1 to 3, especially preferably 1.8 to 2.2.

Step (B) of the process according to the invention can generally be carried out at any temperature deemed suitable by the person skilled in the art, preferably at 5 to 100° C., particularly preferably at 23 to 50° C.

Step (B) of the process according to the invention can generally be carried out at any pressure deemed suitable by the person skilled in the art, preferably at atmospheric pressure.

In step (B), the aqueous dispersion may preferably be stirred, in particular using devices known to those skilled in the art, in particular propeller stirrers, anchor stirrers, dissolver disks, helical stirrers, jet stirrers, for example Visco-Jet®. The mixing and/or dissolution in step (B) of the process according to the invention may also be carried out by circulation by pumping of the aqueous dispersion (A) using, for example, peristaltic pumps, diaphragm pumps, eccentric screw pumps.

The at least one compound having an antioxidant effect may generally be added in any form deemed suitable to a person skilled in the art, for example as a solid, as a suspension or in the form of a solution. Preference is given to the addition of an aqueous solution of the at least one compound having an antioxidant effect to the aqueous dispersion.

If, according to the invention, the at least one compound having an antioxidant effect is added as an aqueous solution, this generally has a concentration of 0.1 to 1000 g/l, preferably 100 to 1000 g/l.

In step (B) of the process according to the invention, the at least one compound having an antioxidant effect added reacts with the at least one compound having a biocidal effect present in the aqueous dispersion, so that the latter is decomposed. According to the invention, all of the at least one compound having a biocidal effect present is preferably reacted accordingly. After step (B) of the process according to the invention, the concentration of at least one compound having a biocidal effect comprising at least one peroxide group is therefore preferably less than 10 mg/l, particularly preferably 0.5 to 10 mg/l, especially preferably 0.5 to 2 mg/l.

After step (B) of the process according to the invention, an aqueous polyurethane-containing dispersion is preferably obtained which is largely free of compounds having a biocidal effect and can therefore be further processed directly, in particular may be used in step (C) according to the invention. In the context of the present invention, “largely free” preferably means that the at least one compound having a biocidal effect is present at maximum at the concentrations mentioned in the previous paragraph.

However, it is also possible in accordance with the invention for the aqueous dispersion obtained in step (B) to be fed to further work-up steps, for example the addition of biocides which are suitable for further processing. In addition, it is possible to add thickeners, pigments, color pastes, other processing aids, for example defoamers, wetting aids, coagulation aids and/or stabilizers, for example other antioxidants, UV stabilizers. Processes for adding the components mentioned are known per se to those skilled in the art.

According to the invention, the present invention preferably relates to the process according to the invention, wherein at least the following step (C) is carried out after step (B):
(C) production of articles, cosmetics, coatings, adhesive layers or adhesives from the biocide-free, aqueous polyurethane dispersion obtained in step (B).

Appropriate processes carried out in step (C) of the process according to the invention are known per se to those skilled in the art, for example
dip coating, in particular for the manufacture of gloves, preferably for use in the medical field,
production of aqueous adhesive dispersions that are processed with and without crosslinkers, for example isocyanate or polycarbodiimide crosslinkers,
production of latent-reactive adhesive layers, adhesive films or adhesive powders, for example described in EP-A 0 922 720 or EP 2 099 840 B1,
coating of textiles, leather or imitation leather,
use of polyurethane dispersion in hairspray, sunscreens etc.,
coatings on plastics, metallic materials, wood.

Articles preferred according to the invention are selected, for example, from articles produced by dip coating, for example disposable gloves or condoms, covers or so-called sleeves for medical devices, probes, endoscopes, coated textiles, bandages, films for wound dressings, medical foams or so-called wearable patches.

Cosmetics preferred according to the invention are selected, for example, from hairspray, sunscreen cream, conditioner or mascara, etc., more preferably the at least one polyurethane used here serves as a film former.

Coatings preferred according to the invention are selected, for example, from primer, filler, base coat and top coat systems, coatings of wood, metal and plastics, textiles, leather, artificial leather, each in various industries, for example in cars, large vehicles, ACE (agricultural, construction & earth moving equipment), industrial coatings, furniture or fiberglass sizing.

Adhesives preferred according to the invention are selected, for example, from polyurethane dispersion adhesives, which are processed as a 1- or 2-component system, non-reactive and reactive adhesive films, adhesive powders or adhesive layers, applied in each case to substrate surfaces.

The present invention also relates to the use of at least one compound having an antioxidant effect for treating an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

Details and preferred embodiments of the use according to the invention have already been mentioned with respect to the aqueous dispersion according to the invention and with respect to the process according to the invention and apply here accordingly.

The present invention will now be elucidated by reference to working examples.

### EXAMPLES

### Materials and Sources

Polyester I: polyester diol formed from butane-1,4-diol and adipic acid, OH number 50
Desmodur® H: hexamethylene-1,6-diisocyanate, Covestro Deutschland AG
Desmodur® I: isophorone diisocyanate, Covestro Deutschland AG
Desmodur® W: 4,4′-diisocyanatodicyclohexylmethane, Covestro Deutschland AG
PolyTHF® 1000: BASF SE
PolyTHF® 2000: BASF SE
Desmodur® DN: hydrophilically modified polyisocyanates based on hexamethylene diisocyanate, NCO content 20% by weight, Covestro Deutschland AG
Preventol® D7: 1.5% by weight aqueous solution of a mixture of 5-chloro-2-methylisothiazolinone/2-methylisothiazolinone (CAS 55965-84-9), Lanxess Deutschland AG
Hydrogen peroxide: 35% by weight aqueous solution, Merck KGaA
Ascorbic acid: Merck KGaA
Sodium ascorbate: Merck KGaA
Cysteine: Merck KGaA
Acetylcysteine: Merck KGaA
L-Glutathione: Merck KGaA
Methionine: Merck KGaA

### Methods:

Unless otherwise stated, the peroxide concentration in mmol/l in the polyurethane-polyurea dispersions always refers to the peroxide group —O—O— having a molecular weight of 32 g/mol.

### Determination of the Peroxide Concentration:

The peroxide concentration or the presence of biocide having an oxidant effect in the polyurethane-polyurea dispersion was determined semi-quantitatively using the peroxide test strips cited below:
Peroxide test 100 to 1000 mg/l H₂O₂, MQuant, Merck KGaA
QUANTOFIX® Peroxide 25, 0 to 25 mg/l H₂O₂, Macherey-Nagel

The peroxide test 100 to 1000 mg/H₂O₂ from MQuant was only used in the following for the semi-quantitative determination of the peroxide concentration in the polyurethane-polyurea dispersions before adding the reducing agents (additives).

QUANTOFIX® Peroxide 25 is also suitable for detecting peracetic acid and other organic and free inorganic hydroperoxides and was therefore used to determine the peroxide concentration in the polyurethane-polyurea dispersions after adding the reducing agents (additives).

Determination of the bacteriological status of the polyurethane-polyurea dispersions:

the contamination or bacterial growth in the polyurethane-polyurea dispersions was determined using BacTrac 4300 from SY-LAB Geräte GmbH. For this purpose, 1 ml of the polyurethane-polyurea dispersion was poured into the BiMedia 001C measuring cell (order number 41-440011). The measuring cell was sealed with the screw cap (order number 41-440012+) and placed in the measuring station of the BacTrac 4300, which was temperature-controlled to 35° C.

The multiplication of microorganisms in the dispersion sample is accompanied by an increase of metabolic products. The BacTrac 4300 measuring device uses the alternating current resistance (impedance) of the sample as a measure for determining the metabolic products. The threshold (E) can be set individually. If the threshold value (E) is exceeded, the sample is considered to be sterile. For all measurements, the threshold value (E) was set at 8 and the maximum measurement duration at 50 hours. The temperature of the sample was 35° C. during the measurement. The data in Table 1 refers to the time [h] until the threshold value (E) is reached.

### Biocidal Effect (BacTrac Test):

The polyurethane-polyurea dispersion 1 (PUD 1) contaminated with bacteria was mixed with Preventol D7 (comparative example) and with hydrogen peroxide as biocides. Immediately after adding the biocides, the determination of the bacteriological status of the polyurethane-polyurea dispersions using the BacTrac 4300 was started.

### Polyurethane-Polyurea Dispersion 1 (PUD 1):

450 g of polyester I were dewatered for 1 hour at 110° C. and 15 mbar. At 80° C., 30.11 g of Desmodur® H and then 20.14 g of Desmodur® I were added. The mixture was stirred at 80 to 90° C. until a constant isocyanate content of 1.15% by weight had been reached. The reaction mixture was dissolved in 750 g of acetone and cooled to 48° C. Into the homogeneous solution was added a solution of 5.95 g of the sodium salt of N-(2-aminoethyl)-2-aminoethanesulfonic acid and 2.57 g of diethanolamine in 65 g of water with vigorous stirring. After 30 minutes, the mixture was dispersed by addition of 700 g of water. Distillative removal of the acetone affords an aqueous polyurethane-polyurea dispersion having a solids content of 40.0% by weight. The polymer present was semicrystalline after drying with a melting temperature of 48° C. and an enthalpy of fusion of 50.4 J/g.

### Polyurethane-Polyurea Dispersion 2 (PUD 2):

318.8 g of polyester composed of adipic acid, hexanediol and neopentyl glycol having a number-average molecular weight of 1700 g/mol were heated to 65° C. Then 87.9 g of Desmodur® W were added and the mixture was stirred at 125° C. until the actual NCO value had fallen below the theoretical NCO value. The molar ratio of isocyanate groups to hydroxyl groups in the prepolymer formation step was 1.79. The prepolymer was dissolved in 720 g of acetone at 50° C., and then a solution of 33.9 g of diaminosulfonate, 1.6 g of ethylenediamine and 102 g of water was metered in. The subsequent stirring time was 15 minutes. The mixture was dispersed by adding 515 g of water. The acetone was removed by distillation in vacuo. A storage-stable dispersion was obtained, the solids content of which was adjusted to about 40% by weight by adding water.

### Polyurethane-Polyurea Dispersion 3 (PUD 3):

1077.2 g of PolyTHF® 2000, 409.7 g of PolyTHF® 1000, 830.9 g of Desmophen® C2202 and 48.3 g of polyether LB 25 were heated to 70° C. in a standard stirring apparatus. Subsequently, at 70° C., a mixture of 258.7 g of Desmodur H and 341.9 g of Desmodur I was added over 5 min and the mixture was stirred at 120° C. until the theoretical NCO value had been reached or had fallen slightly below the theoretical NCO value. The finished prepolymer was dissolved with 4840 g of acetone and cooled to 50° C., before a solution of 27.4 g of ethylenediamine, 127.1 g of isophoronediamine, 67.3 g of diaminosulfonate and 1200 g of water was added over 10 min. The post-stirring time was 10 min.

The mixture was then dispersed by addition of 654 g of water. This was followed by removal of the solvent by distillation under vacuum. The polyurethane dispersion obtained had a solids content of 61.6% by weight.

The results of the tests of the biocidal effects of the individual biocides used are shown in Table 1 below:

TABLE 1

| | | | Storage for | | |
|---|---|---|---|---|---|
| | | 30 min after | 1 | 1 | 2 |
| No. | Description | addition | week | month | months |
| C1 | 100 g of PUD 1 | 16.8* | 16.1 | 17.45 | 17.4 |
| | (without biocide) | | | | |
| C2 | 100 g of PUD 1 + | 19.3 | sterile | sterile | sterile |
| | 0.1 g of Preventol D7 | | | | |
| 3 | 100 g of PUD 1 + | 36.2 | sterile | sterile | sterile |
| | 0.06 g of hydrogen | | | | |
| | peroxide | | | | |
| | (35% by weight) | | | | |
| 4 | 100 g of PUD 1 + | sterile | sterile | sterile | sterile |
| | 0.14 g of hydrogen | | | | |
| | peroxide | | | | |
| | (35% by weight) | | | | |
| 5 | 100 g of PUD 1 + | sterile | sterile | sterile | sterile |
| | 0.29 g of hydrogen | | | | |
| | peroxide | | | | |
| | (35% by weight) | | | | |

*Measurement started immediately. In the experiments in which a biocide (Preventol D7 or hydrogen peroxide) was added, the first measurement started 30 minutes after the addition in each case. “Sterile” means that the threshold value (E) in the Bac-Trac test is not exceeded within 50 hours. The numerical values in Table 1 represent the time [h] to reach the threshold value (E).

The bactericidal effect of hydrogen peroxide is apparent. Immediately after adding 0.14 g of hydrogen peroxide (35% by weight) (corresponds to 14.4 mmol H₂O₂/kg) to the PUD 1, the dispersion is sterile. After adding 0.1% by weight Preventol D 7, sterility is only achieved after 1 week.

### Decrease in the Peroxide Concentration by Adding the Additives According to the Invention:

To the polyurethane-polyurea dispersions 1 to 3 (PUD 1 to 3) were added 340 ppm (=10 mmol/kg), 680 ppm (=20 mmol/kg) or 3400 ppm (=100 mmol/kg) H₂O₂. The H₂O₂ concentration of the dispersions treated in this way was determined semi-quantitatively using the peroxide test 100 to 1000 mg/l H₂O₂, MQuant, Merck KGaA.

For this purpose, the test strips were dipped into the polyurethane-polyurea dispersion to be measured for 1 second each. After removing the test strips from the dispersion, the test strips were immediately rinsed with ca. 5 ml of distilled water. After a further 30 seconds, the concentration (ppm H₂O₂/l) was determined by comparing the indicator area on the test strip with the comparison scale. The measurement results are shown in Table 2. The ratios listed correspond to the molar ratio of additive to H₂O₂.

TABLE 2
10 mmol of H₂O₂, corresponding to 0.97 g of H₂O₂ (35% by weight in water)/kg
PUD 1 dispersion, corresponds mathematically to 340 ppm H₂O₂, measurement
result 400 ppm H₂O₂, in each case before addition of the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | after | after | after |
| | | of | ratio | adding | adding | adding | adding | adding |
| | | additive | additive: | the | the | the | the | the |
| No. | Additive | [g] | H₂O₂ | additive | additive | additive | additive | additive |
| 6.1 | Ascorbic acid | 0.88 | 0.5:1 | 2 to 5 | 2 to 5 | 2 to 5 | 2 to 5 | 10 |
| 6.2 | Ascorbic acid | 1.76 | 1:1 | 2 to 5 | 2 to 5 | 2 | ≤0.5 | ≤0.5 |
| 6.3 | Ascorbic acid | 3.52 | 2:1 | <2 | ≤0.5 | ≤0.5 | ≤0.5 | ≤0.5 |
| 7.1 | Na ascorbate | 0.95 | 0.5:1 | 2 | 2 | 2 | 2 | 10 |
| 7.2 | Na ascorbate | 1.89 | 1:1 | 2 | 2 | 0.5 to 2 | ≤0.5 | ≤0.5 |
| 7.3 | Na ascorbate | 3.78 | 2:1 | <2 | ≤0.5 | ≤0.5 | ≤0.5 | ≤0.5 |
| 8.1 | Cysteine | 0.61 | 0.5:1 | 10 | 10 | 10 | 10 | 10 |
| 8.2 | Cysteine | 1.21 | 1:1 | 10 | 10 | 10 | 10 | 10 |
| 8.3 | Cysteine | 2.42 | 2:1 | 10 | 10 | 10 | 10 | 10 |
| 9.1 | Acetylcysteine | 0.82 | 0.5:1 | 10 | 5 | 5 | 5 | 10 |
| 9.2 | Acetylcysteine | 1.63 | 1:1 | 10 | 5 | 5 | 5 | 10 |
| 9.2 | Acetylcysteine | 3.26 | 2:1 | 10 | 5 | 5 | 5 | 2 |
| 10.1 | L-Glutathione | 1.54 | 0.5:1 | 10 | 10 | 10 | 10 | 10 |
| 10.2 | L-Glutathione | 3.07 | 1:1 | 10 | 10 | 10 | 10 | 10 |
| 10.3 | L-Glutathione | 6.14 | 2:1 | 10 | 10 | 10 | 10 | 10 |
| 11.1 | Methionine | 0.75 | 0.5:1 | 10 | 10 | 10 | 10 | 10 |
| 11.2 | Methionine | 1.49 | 1:1 | 10 | 10 | 10 | 10 | 10 |
| 11.3 | Methionine | 2.98 | 2:1 | 10 | ≤0.5 | ≤0.5 | ≤0.5 | ≤0.5 |

TABLE 3
20 mmol of H₂O₂, corresponding to 1.94 g of H₂O₂ (35% by weight in water)/kg
PUD 1 dispersion, corresponds mathematically to 680 ppm H₂O₂, measurement
result 800 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | after | after | after |
| | | of | ratio | adding | adding | adding | adding | adding |
| | | additive | additive: | the | the | the | the | the |
| No. | Additive | [g] | H₂O₂ | additive | additive | additive | additive | additive |
| 12.1 | Ascorbic acid | 0.88 | 0.5:1 | 2 to 5 | 2 | 2 | 2 | 10 |
| 12.2 | Ascorbic acid | 1.76 | 1:1 | 2 | 2 | ≤0.5 | <0.5 | <0.5 |
| 12.3 | Ascorbic acid | 3.52 | 2:1 | 2 | <0.5 | <0.5 | <0.5 | <0.5 |
| 13.1 | Na ascorbate | 0.95 | 0.5:1 | 2 | 2 | 2 | 5 | 10 |
| 13.2 | Na ascorbate | 1.89 | 1:1 | 2 | 2 | <0.5 | <0.5 | <0.5 |
| 13.3 | Na ascorbate | 3.78 | 2:1 | <2 | <0.5 | <0.5 | <0.5 | <0.5 |
| 14.1 | Cysteine | 0.61 | 0.5:1 | 10 | 10 | 10 | 10 | 10 |
| 14.2 | Cysteine | 1.21 | 1:1 | 10 | 10 | 10 | 10 | 10 |
| 14.3 | Cysteine | 2.42 | 2:1 | 10 | 10 | 10 | 10 | 10 |
| 15.1 | Acetylcysteine | 0.82 | 0.5:1 | 5 to 10 | 5 | 5 | 5 | 5 |
| 15.2 | Acetylcysteine | 1.63 | 1:1 | 5 to 10 | 5 | 5 | 5 | 5 |
| 15.2 | Acetylcysteine | 3.26 | 2:1 | 5 to 10 | 5 | 5 | 5 | 5 |
| 16.2 | L-Glutathione | 1.54 | 0.5:1 | 10 | 10 | 10 | 5 | 10 |
| 16.2 | L-Glutathione | 3.07 | 1:1 | 10 | 10 | 10 | 5 | 10 |
| 16.3 | L-Glutathione | 6.14 | 2:1 | 10 | 10 | 10 | 5 | <0.5 |
| 17.1 | Methionine | 0.75 | 0.5:1 | 10 | 10 | 10 | 10 | 10 |
| 17.2 | Methionine | 1.49 | 1:1 | 10 | 10 | 10 | 10 | 10 |
| 17.3 | Methionine | 2.98 | 2:1 | 10 | <0.5 | <0.5 | <0.5 | <0.5 |

TABLE 4
100 mmol of H₂O₂, corresponding to 9.71 g of H₂O₂ (35% by weight in water)/kg
PUD 1 dispersion, corresponds mathematically to 3400 ppm H₂O₂, measurement
result >1000 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | after | after | after |
| | | of | ratio | adding | adding | adding | adding | adding |
| | | additive | additive: | the | the | the | the | the |
| No. | Additive | [g] | H₂O₂ | additive | additive | additive | additive | additive |
| 18.1 | Ascorbic acid | 0.88 | 0.5:1 | <0.5 | <0.5 | <0.5 | <0.5 | 2 |
| 18.2 | Ascorbic acid | 1.76 | 1:1 | <0.5 | <0.5 | <0.5 | <0.5 | <0.5 |
| 18.3 | Ascorbic acid | 3.52 | 2:1 | <0.5 | <0.5 | <0.5 | <0.5 | <0.5 |
| 19.1 | Na ascorbate | 0.95 | 0.5:1 | <0.5 | <0.5 | <0.5 | <0.5 | 10 |
| 19.2 | Na ascorbate | 1.89 | 1:1 | <0.5 | <0.5 | <0.5 | <0.5 | <0.5 |
| 19.3 | Na ascorbate | 3.78 | 2:1 | <0.5 | <0.5 | <0.5 | <0.5 | <0.5 |
| 20.1 | Cysteine | 0.61 | 0.5:1 | 5 | 5 | 5 | 10 | 5 |
| 20.1 | Cysteine | 1.21 | 1:1 | 5 | 5 | 5 | 10 | 5 |
| 20.1 | Cysteine | 2.42 | 2:1 | 5 | 5 | 5 | 10 | 25 |
| 21.1 | Acetylcysteine | 0.82 | 0.5:1 | 5 | 2 to 5 | 2 to 5 | 5-10 | 5 |
| 21.1 | Acetylcysteine | 1.63 | 1:1 | 5 | 2 to 5 | 2 to 5 | 5-10 | 5 |
| 21.1 | Acetylcysteine | 3.26 | 2:1 | 5 | 2 to 5 | 2 to 5 | 10 | 0.5-2 |
| 22.1 | L-Glutathione | 1.54 | 0.5:1 | 5-10 | 5 to 10 | 5 to 10 | 10 | 5 |
| 22.2 | L-Glutathione | 3.07 | 1:1 | 5-10 | 5 to 10 | 5 to 10 | 10 | 5 |
| 22.3 | L-Glutathione | 6.14 | 2:1 | 5-10 | 5 to 10 | 5 to 10 | 10 | <0.5 |
| 23.1 | Methionine | 0.75 | 0.5:1 | 10 | 5 to 10 | 10 | 10 | 10 |
| 23.2 | Methionine | 1.49 | 1:1 | 10 | 5 to 10 | 10 | 10 | 10 |
| 23.3 | Methionine | 2.98 | 2:1 | 10 | <0.5 | <0.5 | <0.5 | <0.5 |

TABLE 5
10 mmol of H₂O₂, corresponding to 0.97 g of H₂O₂ (35% by weight in water)/kg
PUD 2 dispersion, corresponds mathematically to 340 ppm H₂O₂, measurement
result 400 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | after | after | after |
| | | of | ratio | adding | adding | adding | adding | adding |
| | | additive | additive: | the | the | the | the | the |
| No. | Additive | [g] | H₂O₂ | additive | additive | additive | additive | additive |
| 24.1 | Na ascorbate | 0.95 | 0.5:1 | 2 | 2 | <0.5 | <0.5 | <0.5 |
| 24.2 | Na ascorbate | 1.89 | 1:1 | 2 | <0.5 | <0.5 | <0.5 | <0.5 |
| 24.3 | Na ascorbate | 3.78 | 2:1 | 2 | <0.5 | <0.5 | <0.5 | <0.5 |

TABLE 6
20 mmol of H₂O₂, corresponding to 1.94 g of H₂O₂ (35% by weight in water)/kg
PUD 2 dispersion, corresponds mathematically to 680 ppm H₂O₂, measurement
result 800 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | after | after | after |
| | | of | ratio | adding | adding | adding | adding | adding |
| | | additive | additive: | the | the | the | the | the |
| No. | Additive | [g] | H₂O₂ | additive | additive | additive | additive | additive |
| 25.1 | Na ascorbate | 1.89 | 0.5:1 | 2 | 2 | 2 | 2 | 2 |
| 25.2 | Na ascorbate | 3.78 | 1:1 | 2 | <0.5 | <0.5 | <0.5 | <0.5 |
| 25.3 | Na ascorbate | 7.56 | 2:1 | 2 | <0.5 | <0.5 | <0.5 | <0.5 |

TABLE 7
100 mmol of H₂O₂, corresponding to 9.71 g of H₂O₂ (35% by weight in water)/kg
PUD 2 dispersion, corresponds mathematically to 3400 ppm H₂O₂, measurement
result >1000 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | after | after | after |
| | | of | ratio | adding | adding | adding | adding | adding |
| | | additive | additive: | the | the | the | the | the |
| No. | Additive | [g] | H₂O₂ | additive | additive | additive | additive | additive |
| 26.1 | Na ascorbate | 9.45 | 0.5:1 | <0.5 | <0.5 | <0.5 | 2 | 2 |
| 26.2 | | 18.9 | 1:1 | <0.5 | <0.5 | <0.5 | <0.5 | <0.5 |
| 26.3 | | 37.8 | 2:1 | <0.5 | <0.5 | <0.5 | <0.5 | <0.5 |

TABLE 8
10 mmol of H₂O₂, corresponding to 0.97 g of H₂O₂ (35% by weight in water)/kg
PUD 3 dispersion, corresponds mathematically to 340 ppm H₂O₂, measurement
result 400 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | direct | after | after |
| | | of | ratio | adding | adding | addition | adding | adding |
| | | additive | additive: | the | the | of the | the | the |
| No. | Additive | [g] | H₂O₂ | additive | additive | additive | additive | additive |
| 27.1 | Na ascorbate | 0.95 | 0.5:1 | 10 to 25 | 10 to 25 | 10 to 25 | — | — |
| 27.2 | Na ascorbate | 1.89 | 1:1 | 5 to 10 | <0.5 | <0.5 | — | — |
| 27.3 | Na ascorbate | 3.78 | 2:1 | 2 | <0.5 | <0.5 | — | — |

TABLE 9
20 mmol of H₂O₂, corresponding to 1.94 g of H₂O₂ (35% by weight in water)/kg
PUD 3 dispersion, corresponds mathematically to 680 ppm H₂O₂, measurement
result 800 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | direct | after | after |
| | | of | ratio | adding | adding | addition | adding | adding |
| | | additive | additive: | the | the | of the | the | the |
| No. | Additive | [g] | H₂O₂ | additive | additive | additive | additive | additive |
| 28.1 | Na ascorbate | 1.89 | 0.5:1 | 10 to 25 | 10 to 25 | 10 to 25 | — | — |
| 28.2 | Na ascorbate | 3.78 | 1:1 | 2 to 5 | <0.5 | <0.5 | — | — |
| 28.3 | Na ascorbate | 7.56 | 2:1 | <0.5 | <0.5 | <0.5 | — | — |

TABLE 10
100 mmol of H₂O₂, corresponding to 9.71 g of H₂O₂ (35% by weight in water)/kg
PUD 3 dispersion, corresponds mathematically to 3400 ppm H₂O₂, measurement
esult >1000 ppm H₂O₂, in each case before adding the additive

| | | | | Measured concentration H₂O₂ [ppm] | | | | |
|---|---|---|---|---|---|---|---|---|
| | | | | Directly | 1 day | 3 days | 1 week | 2 weeks |
| | | Amount | Molar | after | after | direct | after | after |
| | | of | ratio | adding | adding | addition | adding | adding |
| | | additive | additive: | the | the | of the | the | the |
| No. | Additive | [g] | H₂O₂ | additive | additive | additive | additive | additive |
| 29.1 | Na ascorbate | 9.45 | 0.5:1 | 0.5 to 2 | 0.5 to 2 | 10 to 25 | — | — |
| 29.2 | Na ascorbate | 18.9 | 1:1 | <0.5 | <0.5 | <0.5 | — | — |
| 29.3 | Na ascorbate | 37.8 | 2:1 | <0.5 | <0.5 | <0.5 | — | — |

All values in the tables were determined using QUANTOFIX® peroxide 25.0 to 25 mg/l H₂O₂. “-” means that no measurements were carried out.

The mode of action of the additives is obvious. Immediately after the addition of these additives, the H₂O₂ concentration drops significantly below the value of the dispersion prior to the addition of the additives.

### Biocidal Effect and Destruction of the Biocidal Effect by Adding the Antioxidant (BODE Dip Slides Combi Test):

The investigations are carried out according to the package insert (instructions for use) enclosed with the test. The lid of the BODE Dip Slide Combi test tube with the culture medium carrier is unscrewed and removed from the test tube. The culture medium carrier is immersed in the polyurethane-polyurea dispersion for 5 to 10 seconds. Excess polyurethane-polyurea dispersion is left to drain off well. The lower edge of the culture medium carrier is dabbed with a clean filter paper. The culture medium prepared in this way is returned to the test tube and the lid screwed on. The test tube with the prepared culture medium is stored in a climate cabinet at 35° C. Bacterial growth on the culture medium can be determined by visually comparing the culture medium carrier with the comparison scale shown in the package insert.

The scale depicts the number of CFU (colony forming units) between 10² CFU and 10⁷ CFU. Up to 10⁴ CFU the sample is considered to be very weakly to weakly contaminated, from 10⁶ CFU the sample is considered to be heavily to very heavily contaminated.

The polyurethane-polyurea dispersion PUD 1 (experiment 30) contaminated with bacteria was admixed with 20 mmol/kg or 100 mmol/kg hydrogen peroxide solution (experiment 31 or 32).

Immediately after the addition of the hydrogen peroxide solution, sodium ascorbate solution was added to destroy the hydrogen peroxide (experiment 33 and 34). Immediately after the addition of sodium ascorbate solution, the samples were inoculated with 10 g of contaminated PUD 1 (experiment 35 and 36). The results are shown in Table 11:

TABLE 11
Results of the BODE Dip Slides Combi tests

| Experiment | 30 | 31 | 32 | 33 | 34 | 35 | 36 |
|---|---|---|---|---|---|---|---|
| PUD 1 [g] | 100 | 99.81 | 99.03 | 99.81 | 99.03 | 99.81 | 99.03 |
| Hydrogen peroxide | — | 0.19 | 0.97 | 0.19 | 0.97 | 0.19 | 0.97 |
| (35% in water) [g] | | | | | | | |
| Sodium ascorbate solution | — | — | — | 7.56 | 37.8 | 7.56 | 37.8 |
| (10% in water) [g] | | | | | | | |
| PUD 1 [g] | — | — | — | — | — | 10 | 10 |
| Dip Test [t] | 2 | 7 | 7 | 7 | 7 | 7 | 7 |
| | days | days | days | days | days | days | days |
| Result of dip test [CFU] | 10⁷ | <10² | <10² | 10⁵ | 10⁵ | 10⁷ | 10⁷ |

All data in the table in [g]

Contamination of PUD 1 with bacteria is evident. After just 2 days of the dip test, the sample (experiment 30) is evaluated at 107 CFU, i.e. there is heavy to very heavy contamination.

The effect of hydrogen peroxide is also confirmed in the dip test. After adding 20 mmol/kg or 100 mmol/kg hydrogen peroxide (35% solution in water) to the contaminated PUD 1, a value of <10² CFU, i.e very weak to weak contamination, is found after 7 days (experiments 31 and 32).

Destruction of hydrogen peroxide after adding 10% sodium ascorbate solution (molar ratio of sodium ascorbate: peroxide=2:1) is also evident, see experiments 33 and 34.

By inoculating the initially sterile samples with PUD 1, heavy to very heavy contamination of the sample is found after 7 days, see experiments 35 and 36.

1. An aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion.

2. The aqueous dispersion of claim 1, wherein the at least one polyurethane is based on polyether polyols, polyester polyols, polycarbonate polyols or mixtures thereof.

3. The aqueous dispersion of claim 1, wherein the at least one compound having a biocidal effect is selected from the group consisting of hydrogen peroxide, alkali metal and alkaline earth metal peroxides, sodium hyperoxide, peroxomonosulfuric acid, peroxodisulfuric acid, peracetic acid, sodium percarbonate and mixtures thereof.

4. The aqueous dispersion of claim 1, wherein the at least one polyurethane is present in an amount of 5 to 64% by weight, on the total aqueous dispersion.

5. The aqueous dispersion of claim 1, further comprising additional components selected from the group consisting of: binders, assistants, additives, fillers, auxiliaries, leveling agents, reactive diluents, plasticizers, neutralizing agents, catalysts, auxiliary solvents, thickeners, additives, tackifiers and mixtures thereof.

6. A process for producing a biocide-free aqueous polyurethane dispersion, comprising:
(A) providing an aqueous dispersion comprising at least one polyurethane and at least one compound having a biocidal effect, wherein the at least one compound having a biocidal effect comprises at least one peroxide group and is present in an amount of 0.01 to 1000 mmol/kg, based on the total aqueous dispersion, and
(B) treating the aqueous dispersion from step (A) with at least one compound having an antioxidant effect in order to obtain the biocide-free aqueous polyurethane dispersion.

7. The process of claim 6, wherein the at least one compound having an antioxidant effect is selected from the group consisting of ascorbic acid, salts of ascorbic acid, cysteine, acetylcysteine, L-glutathione, methionine and mixtures thereof.

8. The process of claim 6, wherein alkali metal salts of ascorbic acid are used as the compound having an antioxidant effect.

9. The process of claim 6, wherein the at least one compound having an antioxidant effect is added in a molar ratio of peroxide (—O—O—) to antioxidant of 0.1 to 10.

10. The process of claim 6, further comprising step (C). after step (B):
(C) production of articles, cosmetics, coatings, adhesive layers or adhesives from the biocide-free, aqueous polyurethane dispersion obtained in step (B).

11. The process of claim 6, wherein step (B) is conducted at 5 to 100° C., at 23 to 50° C.

12. (canceled)

13. The aqueous dispersion of claim 4, wherein the at least one polyurethane is present in an amount of 30 to 60% by weight, based on the total aqueous dispersion.

14. The aqueous dispersion of claim 13, wherein the at least one polyurethane is present in an amount of 40 to 50% by weight, based on the total aqueous dispersion.

15. The process of claim 8, wherein the alkali metal salts of ascorbic acid comprises sodium ascorbate.

16. The process of claim 9, wherein the at least one compound having an antioxidant effect is added in a molar ratio of peroxide (—O—O—) to antioxidant of 1 to 3.

17. The process of claim 16, wherein the at least one compound having an antioxidant effect is added in a molar ratio of peroxide (—O—O—) to antioxidant of 1.8 to 2.2.

18. The process of claim 11, wherein step (B) is conducted at 23 to 50° C.
